(19) United States
(12) Patent Application Publication
(10) Pub. No.: US 2007/0020576 A1
(43) Pub. Date: Jan. 25, 2007

(54) Animal cleaning system and method

(75) Inventors: Matthew S. Osborn, Eureka, KS (US); Aaron L. Graves, Wichita, KS (US)

Correspondence Address: CARGILL, INCORPORATED, LAW/24, 15407 MCGINTY ROAD WEST, WAYZATA, MN, 55391, US

(73) Assignee: Cargill, Incorporated, Wayzata, MN (US)

(21) Appl. No.: 11/488,279

(22) Filed: Jul. 18, 2006

Related U.S. Application Data
(60) Provisional application No. 60/700,762, filed on Jul. 20, 2005.

(51) Int. Cl. A61D 5/00; A61C 17/02

(52) U.S. Cl. 433/1; 433/80

(57) ABSTRACT

An animal cleaning system and method is provided by the invention. The system comprises a source of cleaning solution and a spray washer having a handle, a valve, a trigger and a nozzle for spraying cleaning solution into the oral cavity of an animal carcass. The method includes the steps of providing a carcass including an oral cavity, providing an apparatus constructed and arranged for application of an aqueous cleaning solution to the oral cavity, and spraying cleaning solution in the oral cavity to remove debris, fiber and ingesta staining therefrom.

### CROSS-REFERENCE TO RELATED APPLICATIONS

The present application claims the benefit of U.S. Provisional Application No. 60/700,762, filed Jul. 20, 2005 titled APPARATUS AND METHOD FOR CLEANING THE ORAL CAVITY OF AN ANIMAL, filed Jul. 20, 2005, incorporated herein by reference.

### BACKGROUND

Oral cavity debris, fiber and staining are a concern in the animal slaughter industry. Animal heads are regularly inspected during the slaughter operation. If inspectors observe ingesta staining in the oral cavity of an animal, the entire head of the animal is condemned. As a result, tissue in the head which can normally be recovered and sold is lost in those heads that are condemned. Ingesta staining is a common cause of staining of the oral cavity of animal heads, particularly of the tongues. If the ingesta stain cannot be removed or sufficiently reduced, the entire animal head is condemned. It has been found that with prior art equipment, warm water rinsing alone is insufficient to remove or sufficiently reduce ingesta staining in the oral cavity of animal heads.

### SUMMARY OF THE INVENTION

An apparatus and method for cleaning an oral cavity of an animal carcass is provided by the present invention. An apparatus for delivering an aqueous cleaning solution to an animal carcass oral cavity is provided by the present invention. The apparatus is a hand-valve-controlled high pressure washer comprising a valve, an actuator or trigger, a wand, a first fluid conduit and a spray nozzle for delivering an amount of the aqueous cleaning solution to an animal oral cavity. In one embodiment, the nozzle is a hand directed spray nozzle. In another, the nozzle is a machine oscillated spray nozzle. In one embodiment, the cleaning solution is water.

In an alternative embodiment, an apparatus is provided wherein the first conduit delivers water, and a second conduit delivers a concentrated aqueous stain removing solution comprising an oxygen bleaching agent. In one embodiment, water is provided at an elevated temperature, and the concentrated solution is provided at a temperature below about 50 degrees F., and a mixing chamber is provided for receiving elevated temperature water and concentrated aqueous stain removing solution and mixing to provide an aqueous bleaching agent solution characterized by a pH of between about 9.5 and about 12.0, and a temperature between about 100.degrees Fahrenheit and about 140.degrees Fahrenheit. The apparatus additionally includes a spray nozzle constructed and arranged for delivering a metered amount of the aqueous stain removing solution to an animal oral cavity.

In an alternative embodiment, the agent is an oxygen bleaching agent, as described in U.S. Pat. No. 5,928,074, to Schrader et al., incorporated herein by reference in its entirety. An aqueous sodium percarbonate solution having a weight percent of sodium percarbonate between about 1% by weight and about 8% by weight is preferable because sodium percarbonate has been approved by the U.S.D.A. for use in processing other food products. In order to provide desired alkaline drive for oxygen bleaching, it is preferred that the solution is provided at a pH of between about 9.5 and about 12.0. In addition, the temperature of the solution at the time of application should be greater than 100 degrees Fahrenheit, and preferably between about 110 degrees Fahrenheit and about 130 degrees Fahrenheit.

The method includes a step of providing an animal carcass including a body and attached head, wherein the head includes an oral cavity having oral cavity staining. It should be understood that the method can be adapted for use in a slaughter operation during on-line processing of an animal carcass. A cleaning solution is applied to the oral cavity tissue to remove oral cavity staining and debris.

In one embodiment, the cleaning solution comprises an aqueous stain removing solution which includes an agent other than water which assists in the removal of ingesta staining of the oral cavity of an animal carcass, and the method includes a further step of applying an aqueous cleaning solution to the oral cavity and allowing the solution to remain in contact with the oral cavity. Generally length of time is between about 1 minute and about 5 minutes. The method additionally includes a step of removing the aqueous cleaning solution from the oral cavity.

A method for processing animals is additionally provided by the present invention. The method includes a step of providing an animal having a carcass including a body and an attached head, wherein the animal has been bled for at least about 6 minutes. The head includes an oral cavity including oral cavity tissue, such as tongue and mouth lining. The method includes a step of providing an apparatus for delivering an aqueous cleaning solution, and applying aqueous cleaning solution to at least a portion of the oral cavity tissue and allowing the solution to remain in contact with the oral cavity tissues for at least 30 seconds. The solution is then removed from the oral cavity and the head is separated from the body. Both the head and the body are then processed separately for the recovery of edible products.

A method for reducing bacterial level in an animal carcass or a cavity is provided by the present invention. The method includes a step of providing an animal including a body and attached head, wherein the head includes an oral cavity and oral cavity tissue. The method includes a step of applying an aqueous cleaning solution to at least a portion of the oral cavity tissue and allowing the cleaning solution to remain in contact with the tissue for at least 30 seconds. In one embodiment, the animal is a bovine animal. In one embodiment, the animal is porcine.

In an alternative embodiment, the cleaning solution comprises a stain removing aqueous solution of sodium percarbonate, and the method includes an additional step of rinsing the solution from the oral cavity with potable water. It is expected that this method will provide a reduction of Coliforms level by at least about 0.25 log.

### BRIEF DESCRIPTION OF THE DRAWINGS

FIG. 1 shows a schematic view of an apparatus for cleaning an oral cavity of an animal carcass;

FIG. 2 shows a partial perspective view of the apparatus;

FIG. 3 shows a perspective view of a nozzle of the apparatus;

FIG. 4 shows a cross sectional view along line 4-4 of FIG. 2;

FIG. 5 shows a cross sectional view of an alternative embodiment;

FIG. 6 shows a cross sectional view of an alternative embodiment;

FIG. 7 shows a side view of a nozzle of the apparatus,

FIG. 8 is a longitudinal cross sectional view of the embodiment shown in FIG. 7;

FIG. 9 is a longitudinal cross sectional view of an alternative embodiment;

FIG. 10 shows a schematic view of an alternative embodiment of the apparatus;

FIG. 11 shows a partial perspective view of an alternative embodiment of the apparatus;

FIG. 12 shows a cross sectional view of an alternative embodiment along line 12-12 of FIG. 11;

FIG. 13 a perspective view of a nozzle of the apparatus;

FIG. 14 is a side view of the a nozzle of the apparatus; and

FIG. 15 is a longitudinal cross sectional view of an alternative embodiment.

### DETAILED DESCRIPTION OF THE PREFERRED EMBODIMENTS

In the context of the present invention, the oral cavity refers to mouth of an animal and includes the tongue and mouth lining. The oral cavity is not meant to encompass the esophagus and later alimentary canal tissue including the stomach or intestines.

The slaughter operation generally begins with a step of individually stunning an animal. This is generally done by introducing an electrical shock that renders the animal unconscious. It should be understood that reference herein to a “carcass” generally refers to an animal after it has been stunned and rendered unconscious. In addition, the carcass refers to the body and the head when they are attached, and to the body only when the head is removed from the body. Furthermore, it should be understood that the slaughter operation of the present invention is generally an assembly line type operation where each animal is moved and processed along a series of stations. While the following discussion often focuses on the processing of a single animal, it should be understood that the slaughter operation of the present invention includes the processing of numerous animals. In a preferred embodiment of the invention, the processing of the animals for removal of ingesta staining can be referred to as “on line” processing because the animals are processed as normal except that the processing additionally includes the removal of ingesta staining.

Once an animal is rendered unconscious, it is bled and elevated by its hind legs. It has been found that gravity can cause certain bodily fluids to move from the digestive tract and into the oral cavity. The flow of fluids through the oral cavity is generally slow and continuous until the head is severed. Once the animal has been bled, which usually takes at least about 6 minutes, the carcass is processed to remove hair and debris. This processing involves scalding the carcass in a tank of hot water for about 7 minutes, followed by steps of singeing, polishing, rinsing, and scraping the carcass.

After the carcass has been bled and scalded, the oral cavity is cleaned to remove debris and ingesta staining. It is desirable to delay cleaning of the oral cavity until internal fluids have moved from the digestive tract. Generally, this means that the cleaning of the oral cavity is conducted at least about 13 minutes after the animal was stunned.

In the method of the present invention, a cleaning solution is applied by spray application. The spray is an aqueous cleaning fluid which is applied to the oral cavity for a time sufficient to remove debris and fiber, and clean the areas of ingesta staining. It has been found that this spray time is generally between about 0.5 and about 180 seconds per oral cavity. The solution is applied at as warm a temperature as possible without damaging or denaturing the oral cavity tissue. In general, this means that the temperature of the solution should be less than about 180 degrees Fahrenheit.

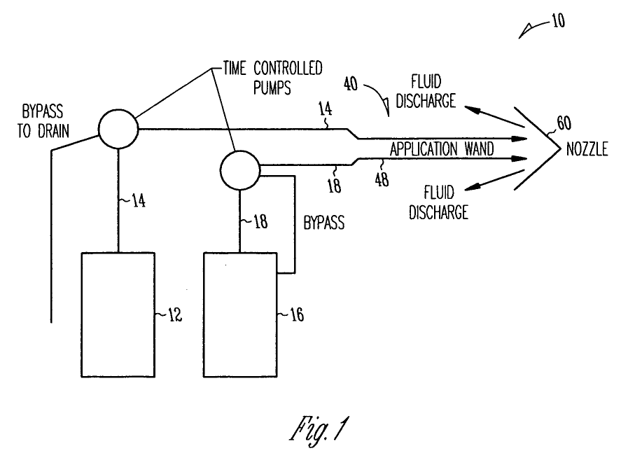

Referring to FIGS. 1-3, in accordance with the present invention, an apparatus 10 for continuous application of cleaning solution, is provided. Apparatus 10 comprises a high pressure cleaner. Apparatus 10 includes a tank 30 (not shown), and a first reservoir 12 for holding a fluid. In one embodiment, the first reservoir is a water reservoir. In one embodiment reservoir 12 further comprises a temperature regulation means, and reservoir 12 provides fluid at a selected temperature. Apparatus 10 includes a manipulatable pressure spraying means in fluid communication with the first reservoir and operable to apply cleaning solution to the oral cavity.

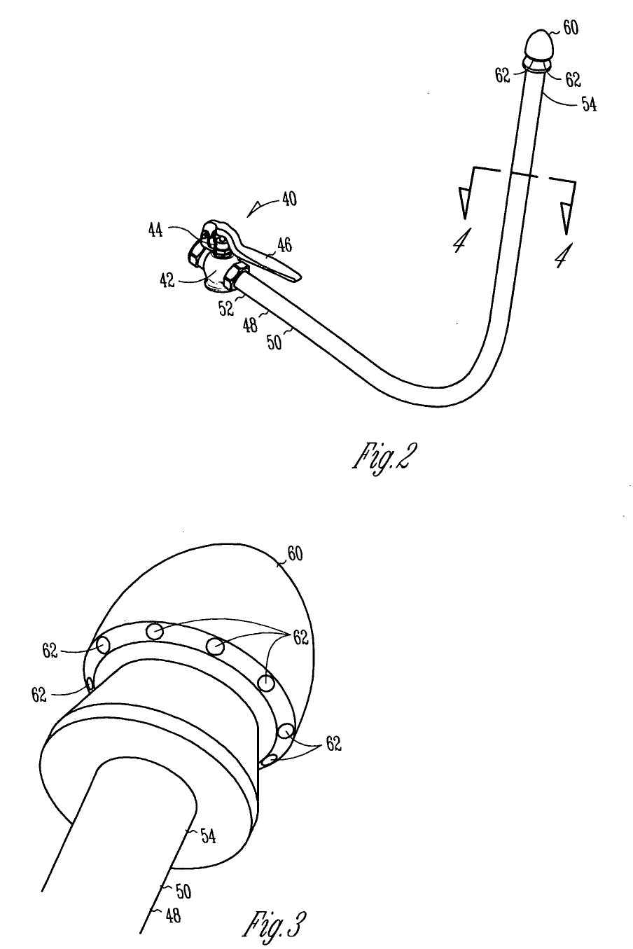

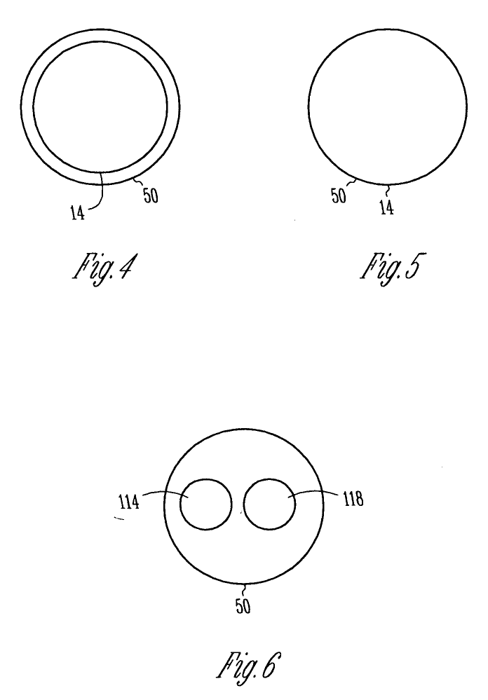

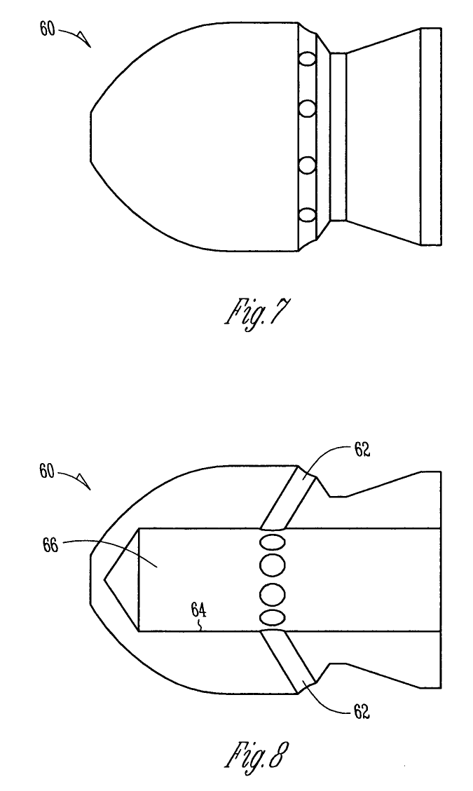

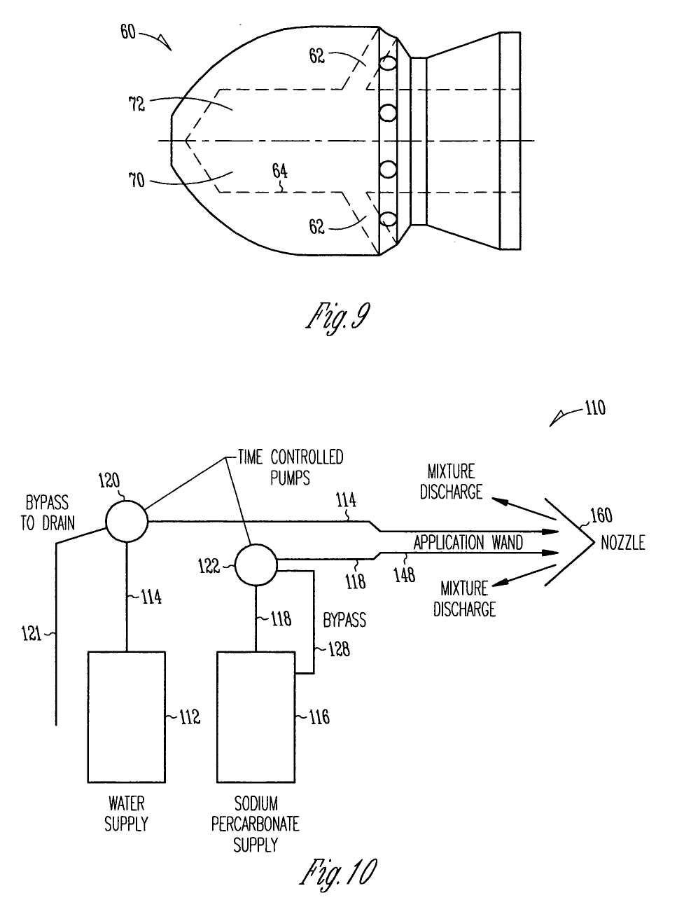

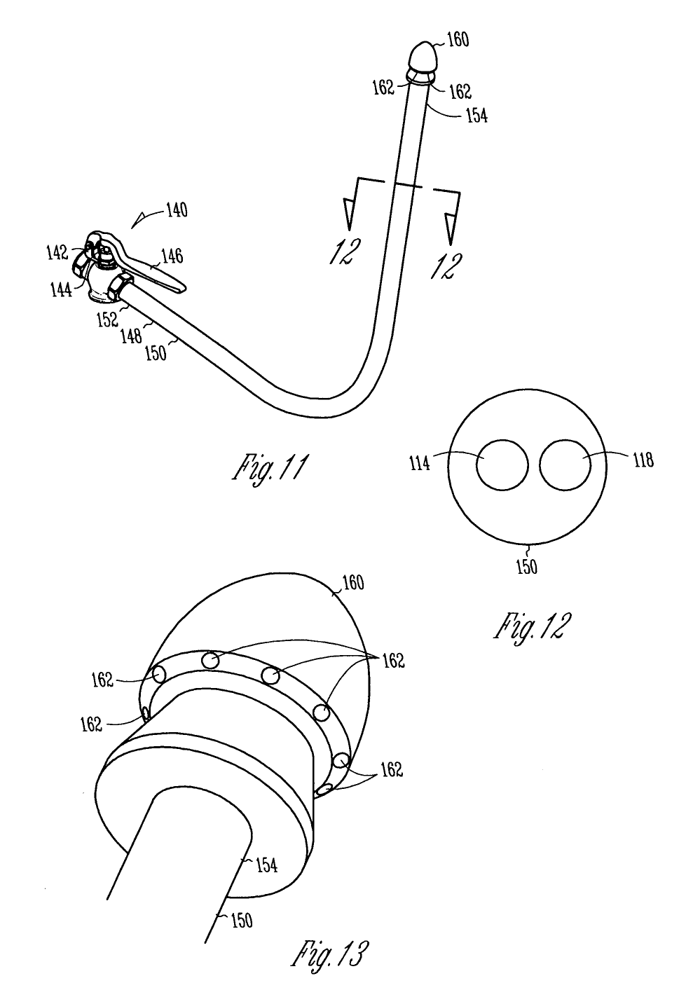

As shown in FIGS. 2-3, spraying means 40 comprises a pressure sprayer 40 having a handle 42 for the individual utilizing the sprayer 40 to hold. Apparatus 10 further comprises an operating switch member and power circuitry controlled thereby connected to the spraying means 40 to apply cleaning solution to the animal oral cavity.

Pressure sprayer further comprises a valve 44, an actuator or trigger 46, an application wand 48, and a spray nozzle 60 constructed and arranged for delivering an amount of aqueous cleaning solution to the animal oral cavity. The wand 48 comprises an elongate, hollow member or housing 50 having a proximal end 52 and a distal end 54, the wand extending distally from the valve 44. The wand 48 carries the nozzle 60 at its distal end. In one embodiment, the nozzle and housing are smooth so the apparatus does not cut or rip the meat. In one embodiment, the housing has a V-shape or curved shape. The housing 50 may be made of any suitable material of which plumbing pipes are made, including but not limited to metals or polymeric materials possessing sufficient rigidity and strength. In one embodiment, the housing 50 is made of stainless steel. The housing 50 may alternatively be made of a semi-rigid material or a flexible material.

Referring now to FIG. 4, within the housing 50 of wand 48, at least one hose is provided, i.e. a first conduit 14 of high pressure hose for carrying cleaning solution, which extends the length of the housing 50, terminating at and in fluid communication with the nozzle 60. First conduit 14 is located in application wand 48, and is in fluid communication with reservoir 12. As shown in FIG. 5, in an alternative embodiment, first conduit 14 is housing 50. In a further alternative embodiment, a number of hoses are provided, to deliver different fluids. For example, as shown in FIG. 6, first conduit 14 and second conduit 18 are shown. Second conduit is in fluid communication with a second reservoir 16, and extends within the housing adjacent to the first conduit.

The nozzle spray is controlled by the actuator or trigger 46 which opens valve 42. Fluid flows through first conduit 14 in response to actuation of trigger 46. Trigger 46 is hand actuated, though other types of actuation may be provided, such as knee or foot activation. In one embodiment, a first timer control 16 is provided to meter or regulate the flow of fluid through first conduit 14. The pressure causes the fluid to spray outward of the nozzle 60 through openings 62.

Referring to FIG. 7, an enlarged side view of the nozzle is shown. In one embodiment, the nozzle may have a proximal portion or neck and a distal portion or head. In a further embodiment, the proximal portion of the nozzle is frusto-conical and the distal portion of the nozzle is rounded, curved or semi-spherical. In one embodiment of the present invention, the nozzle is frusto-conical.

Referring to FIG. 8, a cross section is provided showing the internal structure of the nozzle. Nozzle 60 has an interior chamber 64. In one embodiment, interior chamber 64 is in fluid communication with first conduit 14. In use, fluid exits from openings 62, and the spray therefrom is directed backward in the direction of the handle 42. Thus, when the nozzle 60 is inserted within the animal oral cavity, the spray will not be directed down the throat, but rather spray the inside of the oral cavity. In addition, the individual utilizing the pressure sprayer 40 may pull the wand outward from the oral cavity as the fluid is discharging from the nozzle 60. It is expected that this movement will assist in dislodging any matter found in the oral cavity (as defined hereinabove).

The nozzle may be made of any suitable material, including stainless steel. In one embodiment, the nozzle is made of 416 stainless steel. In one embodiment, the nozzle has a maximum operating pressure of 10,000 PSI. In one embodiment, the nozzle is between about 1.00 to 3.00 inches long, between about 1.20 to 3.80 inches in diameter and its interior chamber is between about 0.25 to 1.25 inches in diameter. In another embodiment of the invention, the nozzle is about 2.00 inches long, about 2.44 inches in diameter and its interior chamber is about 0.75 inches in diameter.

Referring to FIG. 8, interior chamber 66 of nozzle 60 may further comprise a mixing chamber 66 for mixing fluids to be delivered by nozzle 60. In such an embodiment, second conduit 18 is in fluid communication with interior chamber 64, and may deliver compressed air or an alternative fluid, and the fluids delivered by conduits 14, 18 may be mixed in mixing chamber 66.

In a further alternative embodiment, the interior chamber may comprise separate sections. Referring to FIG. 9, in an alternative embodiment, interior chamber 64 of nozzle 60 has sections 70, 72 which are respectively in fluid communication with first and second conduits 14, 18 to separately deliver the fluids. In such an embodiment, the apparatus may be constructed and arranged to deliver the fluids separately from each other at different times. Alternative, the fluids may merely remain separate until after they are delivered, and allowed to mix exterior of the apparatus.

In an alternative embodiment, the apparatus comprises a mixing chamber for receiving a concentrated aqueous cleaning solution and elevated temperature water and mixing the concentrated aqueous cleaning solution and the elevated temperature water to provide an aqueous cleaning solution characterized by a pH of between about 5.5 and about 12, and a temperature of between about 50 degrees Fahrenheit, and about 140 degrees Fahrenheit. The mixing chamber may be provided within nozzle 60, or elsewhere in the apparatus. For example, mixing of one or more components of a solution could occur in a mixing chamber proximal to the fluid reservoirs.

In an alternative embodiment, the stain removing solution is an aqueous solution including an agent (other than water) which assists in the removal of ingesta staining. Preferably, the agent is an oxygen bleaching agent. In the situation where the stain removing solution includes an aqueous sodium percarbonate solution, it is generally desirable for the solution to be applied at as warm a temperature as possible without damaging or denaturing the oral cavity tissue. In general, this means that the temperature of the solution should be less than about 180 degrees Fahrenheit. It has been found that aqueous sodium percarbonate functions better as a bleaching agent when it is provided at elevated temperatures. Thus, if the solution is too cold, sufficient bleaching and/or removal of ingesta staining may not be observed. In general, it is expected that the solution should be applied at a temperature of at least about 100 degrees Fahrenheit, in order to provide sufficient cleaning action. A consideration when is selecting the delivery temperature of the solution in a slaughter operation is the comfort of the operator administering the solution. If the solution is delivered manually, the temperature should not be so great as to cause discomfort to the worker. In this case, the temperature should be between about 110 degrees Fahrenheit, and about 130 degrees Fahrenheit. An optimum temperature for delivering solution manually is about 120 degrees Fahrenheit. By automating the administration of the stain removing solution or otherwise protecting the worker from the temperature of the solution, it is expected that the delivery temperature of the solution can be increased. In such a situation, it is expected that the delivery temperature of the solution can be provided at, for example, between about 130 degrees Fahrenheit, and about 170 degrees Fahrenheit. Even more preferably, the temperature should be between about 140 degrees Fahrenheit, and about 150 degrees Fahrenheit. In an alternative embodiment, a metered amount of stain removing solution is applied. In one embodiment, the stain removing compound comprises about 4% by weight sodium percarbonate, and the metered amount will be between about 20 ml and 60 ml per oral cavity, and more preferably between about 30 ml and about 50 ml. It should be understood that the amount of solution applied should be enough to provide the desired degree of stain removal in a given time period. If too little stain removing solution is used, then the stain removal will be insufficient. If too much stain removing solution is used, then much of the solution will be wasted.

The stain removing solution is then allowed to remain in place on the stained oral cavity tissue in order to act on the stain. The length of time the solution is allowed to remain on the oral cavity is referred to as the dwell time. If the dwell time is too short, then the solution may not provide sufficient stain removal. It is believed that longer dwell times reflect a greater degree of stain removal and a greater extent of solution breakdown. In the case of an aqueous solution containing 4% by weight sodium percarbonate, it has been observed that the sodium percarbonate loses its stain removing ability over time as it breaks down into water, oxygen, carbonate, and sodium. It has been found that for light staining, a dwell time of at least one minute, and more preferably two minutes, is desirable when using an aqueous solution containing 4% by weight sodium percarbonate. For heavy staining, a dwell time of at least three minutes is preferable for an aqueous solution containing 4% by weight sodium percarbonate. For certain applications, it is expected that the dwell time can be as low as 30 seconds and as long as 10 minutes.

It should be appreciated that the upper limit on the dwell time is generally controlled by other steps in the slaughter operation. An advantage of the present invention is that it can be adapted to existing slaughter operations without substantial modifications to the operation. The steps of applying the stain removing solution and rinsing the stain removing solution can be inserted between other steps in the slaughter operation. In particular, the steps of applying the stain removing solution and rinsing the stain removing solution are preferably introduced after the carcass has been bled and scalded, but before inspection of the oral cavity by the government inspectors. It is important to remove the stain removing solution from the oral cavity before the government inspectors evaluate the oral cavity. Thus, although the solution may lose its effectiveness if left on longer than necessary to obtain stain removal, it is expected that the length of time it remains on the oral cavity depends on the other steps occurring in the slaughter operation. For example, in a typical slaughter operation, the earliest the stain-removing solution can generally be applied is after the carcass has been scalded, and it should generally be removed or rinsed away prior to inspection of the oral cavity. It is an advantage of the present invention that the method for removing stains can be adapted to industry accepted slaughter techniques without disruption of the floor operations or significantly delaying the slaughter operation.

In one embodiment of the invention, the stain removing solution is applied after the carcass has been bled, scalded in a hot tank of water, singed to remove hair, and polished twice. Once the stain removing solution has been applied, the carcass is further processed during the dwell time. Specifically, the carcass exterior is again singed and thoroughly rinsed and scraped to remove hair, the hooves are trimmed, and the rectum is loosened and tied off. Although the carcass exterior is rinsed, it is not expected that the rinse water from this step will be directed inside the oral cavity, or that it will wash away significant amounts of the stain removing solution from the oral cavity.

Once the dwell time is complete, the oral cavity is rinsed with warm water. This warm water rinse removes residual stain removing solution and other matter in the oral cavity including ingesta, hair, and other foreign matter. The water is preferably provided at a temperature of between about 90 degrees Fahrenheit and about 120 degrees Fahrenheit and each oral cavity is rinsed for between about 1 and about 3 seconds. A particular oral cavity is rinsed for a sufficient time to remove foreign matter. Prior to the present invention, the oral cavity was rinsed with cold water. It is expected that the rinse time with warm water to remove stain removing solution will not be significantly longer than prior rinse times with cold water.

Once the oral cavity has been rinsed with warm water, the head is severed so that no contamination may flow from the digestive tract through the oral cavity. The head remains attached via skin at the front of the neck. Government inspectors then review each head looking for signs of disease and infection. As part of the inspection, the inspectors observe the glands for inflammation and the oral cavity for ingesta, ingesta staining, and hair. If the inspectors observe the presence of ingesta, ingesta staining, or hair in the oral cavity, the head is condemned. Condemned heads are severed from the carcass and sent to rendering operations where they are further processed into inedible products. Heads that pass the inspection are forwarded on for further processing.

Subsequent to the inspection, the head is later removed from the carcass and is processed by removing the edible portions, i.e., tongue, cheek meat, and ears. In addition to the aforementioned rinsing, certain edible portions may be further processed in batch washing operations. The edible meat can then be further processed and sent on to consumers.

The stain removing solution is applied to the oral cavity during the animal slaughter operation in order to remove ingesta staining found within the oral cavity. By removing the ingesta staining from the tissue in the oral cavity, less heads are condemned and the meat found in the heads can be recovered.

In an alternative embodiment of the invention, the stain removing solution includes an oxygen bleaching agent. A preferred oxygen bleaching agent can be provided by an aqueous solution of sodium percarbonate. It is understood that in an aqueous solution of sodium percarbonate, it is the perhydroxy radical which is the active agent mostly responsible for providing the bleaching action in the oral cavity. Sodium percarbonate which can be used in the stain removing solution according to the present invention is available under the trade name ACTO-140.TM., from Birko Chemical Corporation.

As an alternative stain removing solution, it is expected that sodium perborate would function favorably for removing ingesta staining. It is expected, however, that sodium perborate may not receive government approval for use with animal tissue because a potential residue is boric acid which is toxic and which may remain on tissue if not sufficiently rinsed therefrom. In addition, chlorine bleaching agents may provide sufficient stain removal activity, but it is expected that certain types will cause off flavor to the tissue and may result in the presence of toxic chlorides if not sufficiently washed away. Sodium percarbonate is particularly advantageous because it has received government approval for several applications in the slaughter industry. As an alternative to using sodium percarbonate, it should be understood that one could provide a stain removing solution by mixing hydrogen peroxide with sodium carbonate or other suitable alkaline builder.

An advantage to using an aqueous sodium percarbonate solution is that the solution rinses well. With sufficient rinsing, the sodium percarbonate ionizes and rinses away.

In order to provide for a continuous application of sodium percarbonate solution under the application conditions described above, Applicants have found that an applicator which is depicted in FIG. 10 at reference numeral 110 is preferably utilized. The applicator 110 includes a hot water reservoir 112 and a concentrated bleach reservoir 116. The concentrated bleach reservoir 114 includes a concentrated sodium percarbonate solution in water at a temperature which is sufficiently low to minimize the activity of the solution. In general, sodium percarbonate has a longer shelf life when kept at a cooler temperature. In order to provide the bleaching properties, it must be brought to a higher temperature. The hot water reservoir 112 includes hotter water which when combined with the concentrated sodium percarbonate in reservoir 116 provides a solution of sodium percarbonate at the desired concentration and temperature for bleaching the oral cavity of animals. The concentrated sodium percarbonate flows through line 118 and the hot water through line 114. Timer control pumps 120 and 122 are provided for metering the flow of hot water and concentrated sodium percarbonate through lines 114 and 118, respectively. Applicator 110 is activated by an actuator or trigger 146, which can be hand actuated, or alternatively a hand, knee or foot-actuated pedal. Once the applicator 110 is activated by an actuator or trigger 146, the timer control pumps 120 and 122 meter a predetermined quantity of fluid therethrough. The fluid then flows via lines 114 and 118 through the application wand 148.

The timer control pump 122 includes a bypass line 121 which allows concentrated sodium percarbonate to flow back into the reservoir 114. The timer control pump 120 includes a bypass drain 123 which allows hot water to flow to a drain. The purpose for bypass lines 121 and 123 is to relieve backpressure, and to provide for control of temperature.

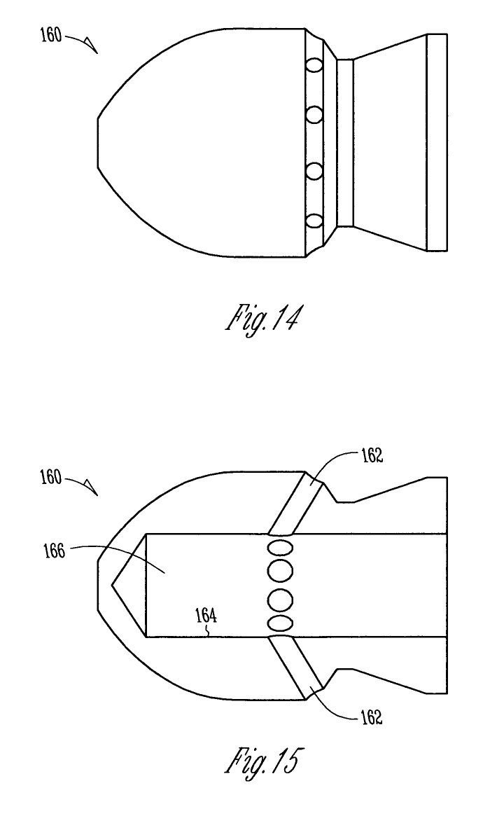

Now referring to FIGS. 11-13, an embodiment of the pressure sprayer is shown at 140. Sprayer 140 includes a handle 142, a valve 144, an actuator or trigger 146, and an application wand 148. Application wand comprises an elongate, hollow member or housing 150. Referring to FIG. 12, a cross section of housing 150 is shown, with first and second lines 114 and 118. The hot water flows through line 114 and the concentrated sodium percarbonate flows through line 118 of housing 150, and are mixed at the nozzle 160. The nozzle 160 has an interior portion 164. Interior portion comprises a mixing chamber 166, wherein the concentrated sodium percarbonate and hot water mix.

The pressure causes the mixture to spray outward of the nozzle 160 through openings 162. It is preferable that the spray is directed backward in the direction of the handle 142. Thus, when the nozzle 160 is inserted within the animal oral cavity, the spray will not be directed down the throat, but rather spray the inside of the oral cavity. In addition, the individual utilizing the application wand 148 may pull the wand outward from the oral cavity as the fluid is discharging from the nozzle 160. It is expected that this movement will assist in dislodging matter found in the oral cavity.

Referring to FIG. 14, an enlarged side view of the nozzle is shown. Referring to FIG. 15, a cross section is provided showing the internal structure of the nozzle. Nozzle 160 has an interior chamber 164. In one embodiment, interior chamber 164 is in fluid communication with first conduit 114. In use, fluid exits from openings 162, and the spray therefrom is directed backward in the direction of the handle 142. Thus, when the nozzle 160 is inserted within the animal oral cavity, the spray will not be directed down the throat, but rather spray the inside of the oral cavity. In addition, the individual utilizing the pressure sprayer 140 may pull the wand outward from the oral cavity as the fluid is discharging from the nozzle 160. It is expected that this movement will assist in dislodging any matter found in the oral cavity.

Referring to FIG. 15, interior chamber 164 of nozzle 160 may further comprise a mixing chamber 166 for mixing fluids to be delivered by nozzle 160. In such an embodiment, first conduit 114 and second conduit 118 are in fluid communication with interior chamber 164, and deliver fluids for mixing in mixing chamber 166.

In one aspect, the present invention is directed to an apparatus for cleaning an animal oral cavity comprising a pressure sprayer. The pressure sprayer comprises a base, an actuator coupled to the base, and a valve operably connected to the actuator, an application wand and a spray nozzle. The valve is positionable between an opened position and a closed position in response to movement of the actuator.

The application wand comprises an elongate hollow member or housing having a proximal end and a distal end, the wand extending distally from the valve. The wand housing is made of any suitable material, for example, a material selected from the group consisting of metals and polymeric materials. The housing may be made of stainless steel. The housing may alternatively be made of a semi-rigid material or a flexible material. In one embodiment, the housing has a V-shape.

The spray nozzle has a proximal end and a distal end, the spray nozzle being carried by the wand at its distal end, the spray nozzle in fluid communication with the wand. The nozzle is constructed and arranged for delivering a cleaning fluid to the oral cavity, the cleaning fluid being supplied to the nozzle through the application wand when the valve is in the opened position. In one embodiment, the spray nozzle includes a plurality of openings positioned to direct the flow of cleaning fluid in a predetermined direction. In a preferred embodiment, the openings are positioned to direct the flow of cleaning fluid toward the proximal end of the nozzle. The wand is configured for providing back and forth movement of the nozzle in the oral cavity for spraying the cleaning fluid in the oral cavity and cleaning the oral cavity.

The apparatus may include at least one hose extending the length of the housing and carried therein, terminating at and in fluid communication with the nozzle. In one embodiment, the apparatus includes a first conduit of high pressure hose for carrying cleaning solution, and a first fluid reservoir operably connected to the first conduit.

In one aspect, the present invention is directed to an apparatus for cleaning an animal oral cavity comprising a conduit for delivery of aqueous cleaning solution, and pressure spraying means in communication with the conduit and operable to apply cleaning solution to the animal oral cavity. The apparatus further comprises an operating switch member and power circuitry controlled thereby connected to the spraying means and to the conduit to apply cleaning solution to the animal oral cavity. The apparatus may include a probe for dislodging debris from the oral cavity. The spraying means further comprises a base, an actuator, and a valve operably connected to the actuator, the valve being positionable between an opened position and a closed position in response to movement of the actuator. The base may comprise a handle for holding the apparatus. The actuator may comprise a trigger. In one embodiment, the spraying means further comprises a spray nozzle constructed and arranged for delivering aqueous cleaning solution to the animal oral cavity.

A further alternative embodiment is directed to an apparatus for delivering an aqueous cleaning solution to the oral cavity of an animal, the apparatus comprising a first conduit for delivery of concentrated aqueous cleaning solution at a temperature below about 50 degrees Fahrenheit, a second conduit for delivery of elevated temperature water, a mixing chamber for receiving concentrated aqueous cleaning solution and elevated temperature water and mixing the concentrated aqueous cleaning solution and the elevated temperature water to provide an aqueous cleaning solution, and a spray nozzle constructed and arranged for delivering an amount of the aqueous cleaning solution to an animal oral cavity. The aqueous solution is characterized by a pH of between about 5.5 and about 12.0, and a temperature of between about 50 degrees Fahrenheit, and about 140 degrees Fahrenheit. In one embodiment, the concentrated solution comprises an aqueous solution comprising between about 1% by weight and about 8% by weight sodium percarbonate. In another embodiment, the elevated temperature water is provided at a temperature of between about 140 degrees Fahrenheit and about 180 degrees Fahrenheit. In a further embodiment, the elevated temperature water and the concentrated solution are mixed at a volume ratio between about 5:1 and 1:5. In a still further embodiment, the spray nozzle is constructed and arranged for delivery of between about 20 ml and 60 ml of aqueous stain removing solution.

In one aspect, the present invention provides a method for cleaning the oral cavity of an animal carcass. The method includes the steps of providing an animal carcass including body and attached head, wherein the head includes an oral cavity, applying an aqueous cleaning solution to the oral cavity by a spray washer comprising spraying means including a nozzle, and a support coupled to the nozzle for back and forth movement in the oral cavity for spraying cleaning solution in the oral cavity, and removing the aqueous cleaning solution from the oral cavity. In one embodiment, the aqueous cleaning solution is provided at a pH of between about 5.5 and about 12.0. In a further embodiment, the aqueous cleaning solution may be provided at a pH of about 7.0. In a still further embodiment, the aqueous cleaning solution is provided at a pH of between about 9.5 and about 12.0. The cleaning solution may comprise water. In one embodiment, the aqueous cleaning solution comprises an aqueous sodium percarbonate solution. In a further embodiment, the aqueous stain removing solution comprises between about 1% by weight and about 8% by weight sodium percarbonate.

In one embodiment, the aqueous stain removing solution is applied to the oral cavity at a temperature of between about 110 degrees Fahrenheit and about 130 degrees Fahrenheit.

In one embodiment, the method includes the step of removing the cleaning solution after a length of time between about 1 minute and about 10 minutes. In a further embodiment, removing the cleaning solution comprises rinsing the oral cavity with rinsing water. The rinsing water may be provided at a temperature of between about 90 degrees Fahrenheit and about 120 degrees Fahrenheit.

In a further embodiment, after the steps of removing the aqueous cleaning solution from the oral cavity, the oral cavity has a pH of between about 5.5 and about 7.5. In one embodiment, the oral cavity has at least one stain, and after the step of removing the aqueous cleaning solution from the oral cavity, the at least one stain is diminished.

In one embodiment, the spray washer further comprises a first conduit for delivery of concentrated aqueous cleaning solution at a temperature below about 50 degrees Fahrenheit, a second conduit for delivery of elevated temperature water, a mixing chamber for receiving concentrated aqueous cleaning solution and elevated temperature water, and the step of providing and applying the aqueous cleaning solution further comprises mixing the concentrated aqueous cleaning solution and the elevated temperature water to provide an aqueous cleaning solution characterized by a pH of between about 5.5 and about 12.0, and a temperature of between about 50 and 140 degrees Fahrenheit, prior to application.

In a still further embodiment, a method is provided for reducing the bacteria level in an animal carcass oral cavity. The method comprises the steps of providing an animal including a body and an attached head, the head including an oral cavity and oral cavity tissue, applying an aqueous cleaning solution to at least a portion of the oral cavity tissue and allowing the solution to remain in contact with the oral cavity tissue for at least 30 seconds, and rinsing the solution from the oral cavity with potable water. In one embodiment, the method includes a step of reducing Coliforms level by at least about 0.25 log. In one embodiment, the animal carcass is bovine. In one embodiment, the animal carcass is porcine.

While the above method is described with respect to present animal processing techniques in the United States, it should be appreciated that the principles of the invention can be applied to slaughter operations in other countries or to operations as they may be conducted in the United States upon subsequent revision of the applicable regulation. The techniques described above are a preferred way for removing or reducing ingesta staining in animals. The following examples are provided for further identifying various features of the invention, and are not meant to limit the scope of protection which is limited only by the claims attached hereto.

What is claimed is:

1. An apparatus for cleaning an animal oral cavity comprising a pressure sprayer, the pressure sprayer further comprising:
a base;
an actuator coupled to the base;
a valve operably connected to the actuator, the valve being positionable between an opened position and a closed position in response to movement of the actuator;
an application wand comprising a housing having a proximal end and a distal end, the wand extending distally from the valve; and
a spray nozzle having a proximal end and a distal end, the spray nozzle being carried by the wand at its distal end, the spray nozzle in fluid communication with the wand, and being constructed and arranged for delivering a cleaning fluid to the oral cavity, the cleaning fluid being supplied to the nozzle through the application wand when the valve is in the opened position, the wand being configured for providing back and forth movement of the nozzle in the oral cavity for spraying the cleaning fluid in the oral cavity and cleaning the oral cavity.

2. The apparatus of claim 1 further comprising at least one hose extending the length of the housing and carried therein, terminating at and in fluid communication with the nozzle.

3. The apparatus of claim 2 wherein the at least one hose is a first conduit of high pressure hose for carrying cleaning solution, and the apparatus further comprises a first fluid reservoir operably connected to the first conduit.

4. The apparatus of claim 3 wherein the spray nozzle further comprises a plurality of openings positioned to direct the flow of cleaning fluid in a predetermined direction.

5. The apparatus of claim 4 wherein the openings are positioned to direct the flow of cleaning fluid toward the proximal end of the nozzle.

6. An apparatus for cleaning an animal oral cavity comprising:
a conduit for delivery of aqueous cleaning solution; and
pressure spraying means in communication with the conduit and operable to apply cleaning solution to the animal oral cavity.

7. The apparatus of claim 6 further comprising an operating switch member and power circuitry controlled thereby connected to the spraying means and to the conduit to apply cleaning solution to the animal oral cavity.

8. The apparatus of claim 6 further comprising a probe for dislodging debris from the oral cavity.

9. The apparatus of claim 6 wherein the spraying means further comprises a base, an actuator, and a valve operably connected to the actuator, the valve being positionable between an opened position and a closed position in response to movement of the actuator.

10. The apparatus of claim 6 wherein the spraying means further comprises a spray nozzle constructed and arranged for delivering aqueous cleaning solution to the animal oral cavity.

11. An apparatus for delivering an aqueous cleaning solution to the oral cavity of an animal, the apparatus comprising:
a first conduit for delivery of concentrated aqueous cleaning solution at a temperature below about 50 degrees Fahrenheit;
a second conduit for delivery of elevated temperature water;
a mixing chamber for receiving concentrated aqueous cleaning solution and elevated temperature water and mixing the concentrated aqueous cleaning solution and the elevated temperature water to provide an aqueous cleaning solution characterized by a pH of between about 5.5 and about 12.0, and a temperature of between about 50 degrees Fahrenheit and about 140 degrees Fahrenheit; and
a spray nozzle constructed and arranged for delivering an amount of the aqueous cleaning solution to an animal oral cavity.

12. The apparatus of claim 11 wherein the concentrated solution comprises an aqueous solution comprising between about 1% by weight and about 8% by weight sodium percarbonate.

13. The apparatus of claim 11 wherein the elevated temperature water is provided at a temperature of between about 140 degrees Fahrenheit and about 180 degrees Fahrenheit.

14. The apparatus of claim 11 wherein the elevated temperature water and the concentrated solution are mixed at a volume ratio between about 5:1 and 1:5.

15. A method for cleaning the oral cavity of an animal carcass, the method comprising steps of:
(a) providing an animal carcass including body and attached head, wherein the head includes an oral cavity;
(b) providing an aqueous cleaning solution and applying the aqueous cleaning solution to the oral cavity by a spray washer comprising spraying means including a nozzle, and a support coupled to the nozzle for back and forth movement in the oral cavity for spraying cleaning solution in the oral cavity; and
(c) removing the aqueous cleaning solution from the oral cavity.

16. A method for cleaning the oral cavity of an animal carcass according to claim 15, wherein the aqueous cleaning solution is provided at a pH of between about 5.5 and about 12.0.

17. A method for cleaning the oral cavity of an animal carcass according to claim 15, wherein the aqueous cleaning solution is provided at a pH of about 7.0.

18. A method for cleaning the oral cavity of an animal carcass according to claim 15, wherein the aqueous cleaning solution is provided at a pH of between about 9.5 and about 12.0.

19. A method for cleaning the oral cavity of an animal carcass according to claim 15, wherein the aqueous cleaning solution comprises an aqueous sodium percarbonate solution.

20. A method for cleaning the oral cavity of an animal carcass according to claim 15, wherein the aqueous stain removing solution comprises between about 1% by weight and about 8% by weight sodium percarbonate.

21. A method for cleaning the oral cavity of an animal carcass according to claim 15, wherein, after the steps of removing the aqueous cleaning solution from the oral cavity, the oral cavity has a pH of between about 5.5 and about 7.5.

22. The method of claim 21 wherein the oral cavity has at least one stain, and after the steps of removing the aqueous cleaning solution from the oral cavity, the at least one stain is diminished.

23. A method for cleaning the oral cavity of an animal carcass according to claim 15 wherein:
the spray washer further comprises:
a first conduit for delivery of concentrated aqueous cleaning solution at a temperature below about 50 degrees Fahrenheit;
a second conduit for delivery of elevated temperature water;
a mixing chamber for receiving concentrated aqueous cleaning solution and elevated temperature water, and
the step of providing and applying an aqueous solution to the oral cavity by the spray washer further comprises mixing the concentrated aqueous cleaning solution and the elevated temperature water to provide an aqueous cleaning solution characterized by a pH of between about 5.5 and about 12.0, and a temperature of between about 50 and 140 degrees Fahrenheit, for application to the oral cavity.

24. A method for reducing bacteria level in an animal carcass oral cavity, the method comprising steps of:
(a) providing an animal including a body and an attached head, the head including an oral cavity and oral cavity tissue;
(b) applying an aqueous cleaning solution to at least a portion of the oral cavity tissue and allowing the solution to remain in contact with the oral cavity tissue for at least 30 seconds; and
(c) rinsing the solution from the oral cavity with potable water.

25. A method for reducing bacteria level in an animal carcass oral cavity according to claim 24, further comprising a step of:
(a) reducing Coliforms level by at least about 0.25 log.

26. The method of claim 25 wherein the animal carcass is bovine.

27. The method of claim 25 wherein the animal is carcass is porcine.
